(19) United States
(12) Patent Application Publication
(10) Pub. No.: US 2009/0271350 A1
(43) Pub. Date: Oct. 29, 2009

(54) APPARATUS AND METHOD FOR ADAPTIVELY RECOMMENDING SERVICE, SYSTEM AND METHOD FOR ADAPTIVELY RECOMMENDING SERVICE, APPARATUS AND METHOD FOR RECOMMENDING SERVICE BASED ON USER'S FAVORITE BASE

(75) Inventors: Qiangze FENG, Beijing (CN); Toshikazu FUKUSHIMA, Beijing (CN)

Correspondence Address: SUGHRUE MION, PLLC, 2100 PENNSYLVANIA AVENUE, N.W., SUITE 800, WASHINGTON, DC, 20037, US

(73) Assignee: NEC (CHINA) CO., LTD, Beijing (CN)

(21) Appl. No.: 12/252,198

(22) Filed: Oct. 15, 2008

(30) Foreign Application Priority Data
Oct. 15, 2007 (CN) 200710162463.8

(51) Int. Cl. G06F 17/30; G06N 5/02

(52) U.S. Cl. 706/47; 707/3; 707/E17.014

(57) ABSTRACT

The present invention relates to an apparatus and method for adaptively recommending service, the apparatus comprises: a semantic analyzing device which analyzes the query from a user semantically; a service selecting device which selects a service which corresponds to the semantically-analyzed query, and updates a service association database according to the selected service; and a service recommending device which searches the service association database according to the selected service to recommend a related service to the user. The present invention also relates to a system and method for adaptively recommending service as well as an apparatus and method for recommending service based on user's favorite base. With the present invention, the data in the service association database can be acquired and adjusted automatically based on the user's service selection history base, thereby enabling provision of associated services for the user. Further, the present invention can recommend service providers to the user based on the user's favorite base and thus provide services with greater flexibility.

### BACKGROUND OF THE INVENTION

1. Field of Invention

The present invention relates to the field of processing natural language, and in particular to an apparatus and a method for adaptively recommending service, a system and a method for adaptively recommending service as well as an apparatus and a method for recommending service based on user's favorite base.

2. Description of Prior Art

Information service allows a user to query information on various service fields and thus has significant market value. Among different query methods, query in natural language conforms to the usage habit of the general public. A service selection system based on natural language allows the user to query different types of services in natural language via the same entry and then selects and returns corresponding service information.

Recently, there have been some natural-language-based service selection systems, however, most of them can return only a service corresponding to the user's query without recommendation of any associated service. Although some systems can recommend associated services, such recommendation is usually based on predefined service association data, and it is impossible to automatically calculate and adjust the correlation between services depending on the user's query. As a result, some un-associated services may be recommended to the user occasionally.

Patent Application No. JP2002351913 proposes a method in which a web service having optimal waiting time can be selected from web services according to the user accessing history to these web services (which particularly contains user name, longest waiting time, service type, latest access time, etc.) so as to avoid excessive load on network and service.

Patent Application No. JP2004054781 discloses a method which can extract key words for retrieval from a user query in natural language and then select from various services the service corresponding to the key words for retrieval and service invocation interfaces.

Patent Application No. JP2004288118 provides a method which can, based on service register data supplied by a service provider, provide a service corresponding to a user query and other services associated with the service. Patent Application No. JP2002351913 and No. JP200454781 cannot recommend any associated service to the user.

Patent Application No. JP2004288118 cannot adjust the correlation between services automatically depending on the user's query, though it can recommend associated services to the user.

### SUMMARY OF THE INVENTION

The present invention is made to address the above problems so that the correlation between services can be adjusted automatically depending on a user query in addition to service recommendation to the user, thereby enabling adaptive provision of more associated services for the user. Further, the present invention can recommend service providers to the user based on the user's favorite base and thus provide services with greater flexibility.

According to the first aspect of the present invention, an apparatus for adaptively recommending service is provided comprising: a semantic analyzing device which analyzes the query from a user semantically; a service selecting device which selects a service which corresponds to the semantically-analyzed query, and updates a service association database according to the selected service; and a service recommending device which searches the service association database according to the selected service to recommend an associated service to the user.

According to the second aspect of the present invention, a method for adaptively recommending service is provided comprising: a semantic analyzing step of analyzing the query from a user semantically; a service selecting step of selecting a service which corresponds to the semantically-analyzed query, and updating a service association database according to the selected service; and a service recommending step of searching the service association database according to the selected service to recommend an associated service to the user.

According to the third aspect of the present invention, a system for adaptively recommending service is provided comprising: a query receiver which receives a user query; a semantic analyzing device which analyzes the query semantically; a service selecting device which selects a service which corresponds to the semantically-analyzed query, and updates a service association database according to the selected service; and a service recommending device which searches the service association database according to the selected service to recommend an associated service to the user; a first answer generator which generates an answer corresponding to the associated service; and an answer sender which sends the answer to the user.

According to the fourth aspect of the present invention, a system for adaptively recommending service is provided comprising a query receiving step of receiving a user query; a semantic analyzing step of analyzing the query semantically; a service selecting step of selecting a service which corresponds to the semantically-analyzed query, and updating a service association database according to the selected service; and a service recommending step of searching the service association database according to the selected service to recommend an associated service to the user; a first answer generating step of generating an answer corresponding to the associated service; an answer sending step of sending the answer to the user.

According to the fifth aspect of the present invention, an apparatus for recommending service based on user's favorite base is provided comprising: a semantic analyzing device which analyzes the query from a user semantically; a service selecting device which selects a service which corresponds to the semantically-analyzed query; and a service recommending device which searches the user's favorite base according to the selected service to recommend a service provider to the user, so that the user can make an access to the service provider.

According to the sixth aspect of the present invention, a method for recommending service based on user's favorite base is provided comprising: a semantic analyzing step of analyzing the query from a user semantically; a service selecting step of selecting a service which corresponds to the semantically-analyzed query; and a service recommending step of searching the user's favorite base according to the selected service to recommend a service provider to the user, so that the user can make an access to the service provider.

### BRIEF DESCRIPTION OF THE DRAWINGS

FIG. 1a is a schematic diagram showing an apparatus for adaptively recommending service according to the present invention;

FIG. 1b is a flowchart showing a method for adaptively recommending service according to the present invention;

FIG. 1c is a schematic diagram showing an apparatus for adaptively recommending service according to a further embodiment of the present invention;

FIG. 1d is a flowchart showing a method for adaptively recommending service according to the further embodiment of the present invention;

FIG. 1e is a schematic diagram showing a system for adaptively recommending service according to the present invention;

FIG. 1f is a flowchart showing a method for adaptively recommending service according to the present invention;

FIG. 2a is an exemplary block diagram showing a service mapping rule base according to the present invention;

FIG. 2b is a flowchart showing a method for generating a service mapping rule base;

FIG. 3 is an exemplary block diagram showing a service selection history base according to the present invention;

FIG. 4 is an exemplary block diagram showing a service association database according to the present invention;

FIG. 5a is a flowchart showing a method for generating a service association database;

FIG. 5b a diagram showing an example of calculating service correlation;

FIG. 6 is a schematic diagram showing a known semantic analyzing method;

FIG. 7 shows an example of selecting a service;

FIG. 8a is a schematic diagram showing a service recommending device;

FIG. 8b is a flowchart showing a method for recommending service according to the first embodiment of the present invention;

FIG. 8c shows an example of recommending service according to the first embodiment of the present invention;

FIG. 8d is a flowchart showing a method for recommending service according to the second embodiment of the present invention;

FIG. 8e shows an example of recommending service according to the second embodiment of the present invention;

FIG. 8f is a flowchart showing a method for recommending service according to the third embodiment of the present invention;

FIG. 8g shows an example of recommending service according to the third embodiment of the present invention;

FIG. 9a is a schematic diagram showing an example of adjusting service correlation;

FIG. 9b is a schematic diagram showing another example of adjusting service correlation;

FIG. 10a is a schematic diagram showing an apparatus for recommending service based on a user's favorite base;

FIG. 10b is a flowchart showing a method for recommending service based on the current user's favorite base;

FIG. 10c is a flowchart showing a method for recommending service based on other users' favorite base;

FIG. 10d shows an example of a user's favorite base;

FIGS. 11a-11d show four examples recommended by service provider based on a user's favorite base;

FIGS. 12a and 12b show schematic diagrams of applying the apparatus for adaptively recommending service according to the present invention to a mobile terminal and an ASP, respectively.

### DETAILED DESCRIPTION OF PREFERRED EMBODIMENTS

Hereafter, a description will be made to the preferred embodiments of the present invention with reference to the figures, throughout which like elements are denoted by like reference symbols or numbers. In the following description, the details of any known function or configuration will not be repeated, otherwise they may obscure the subject of the present invention.

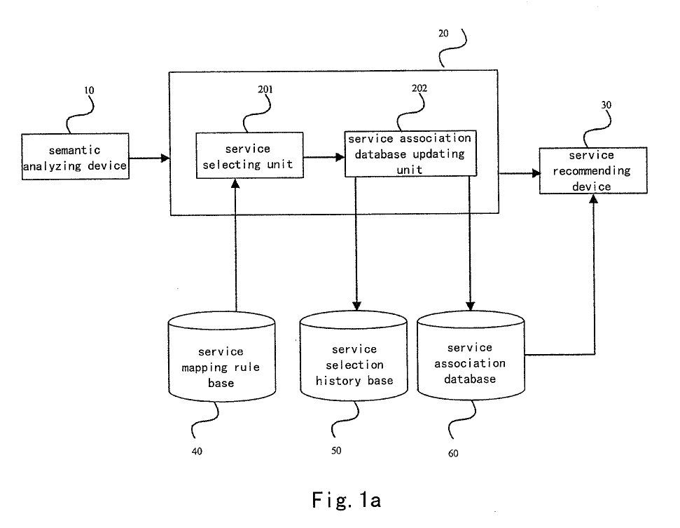

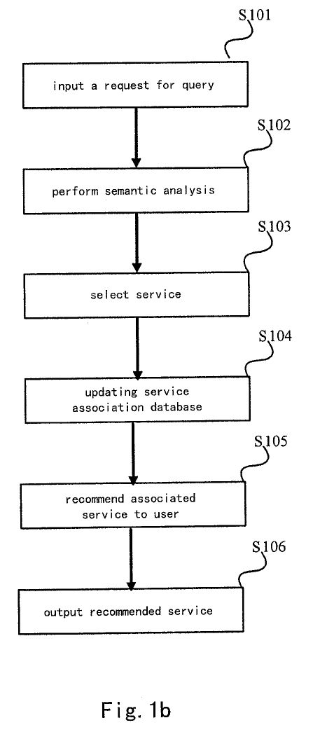

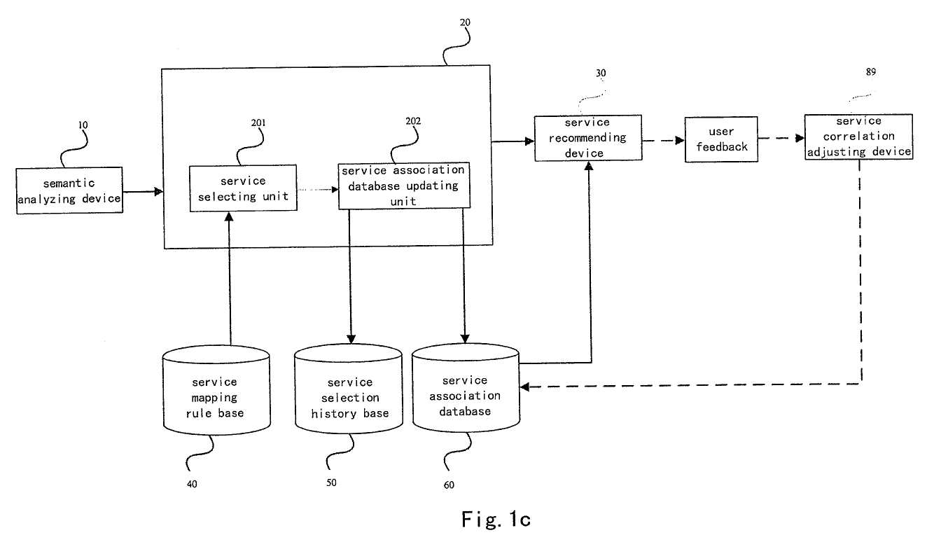

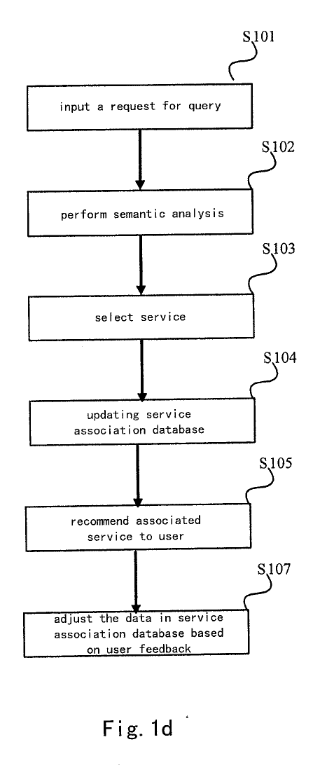

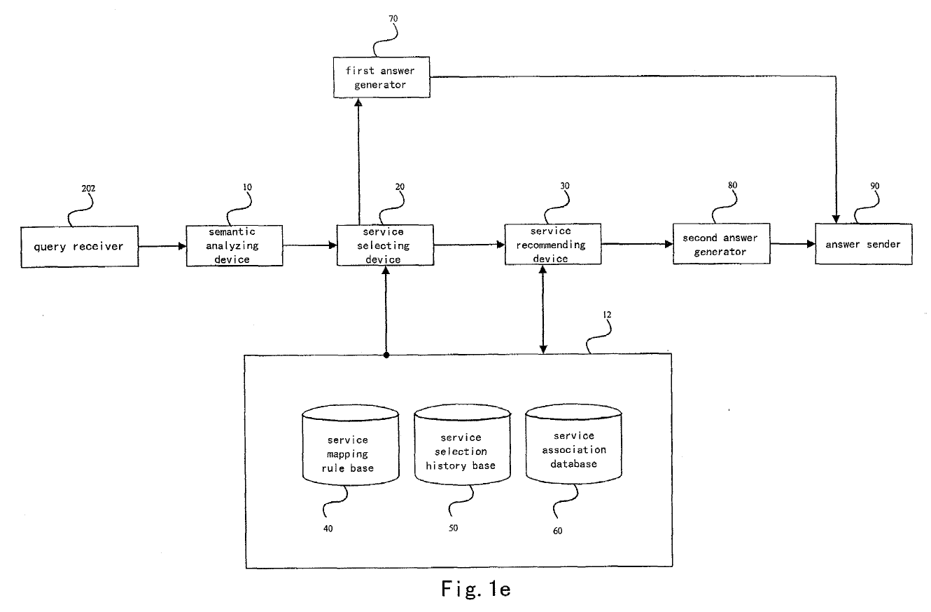

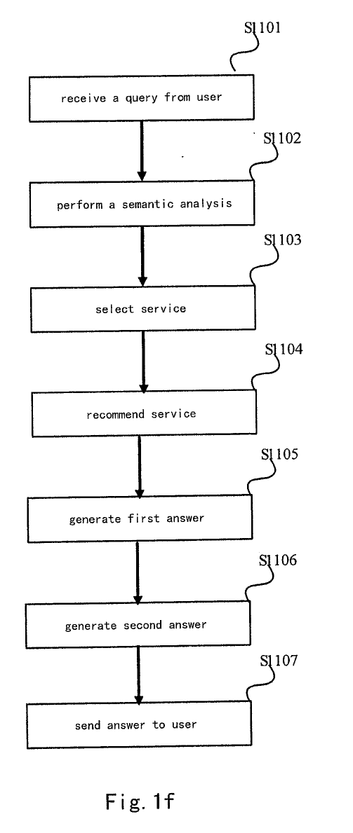

FIG. 1a shows an apparatus for adaptively recommending service according to the present invention, which can analyze and process a query inputted by a user as well as recommend an associated service adaptively. The apparatus for adaptively recommending service comprises: an input device (not show) for inputting a query from a user; a semantic analyzing device 10 for analyzing the received user query, such as a natural language query, to obtain a structured semantic analysis result; a service selecting device 20 including a service selecting unit 201 which selects a service corresponding to the semantic analysis result based on a service mapping rule base 40 and a service association database updating unit 202 which writes the selected service in a service selection history base 50 and thus updates a service association database 60; a service recommending device 30 for acquiring a service associated with the selected service based on the service association database 60 and recommending the associated service to the user; and an output device (not shown) for outputting the recommended service.

The service selecting device 20 writes the selected service in the service selection history base 50 and updates the service association database 60 in real time based on the modified service selection history base 50, so that the apparatus for adaptively recommending service can adjust automatically the correlation data in the service association database 60 according to the user's service selection history base 50 and thus recommend the associated service to the user in an adaptive way.

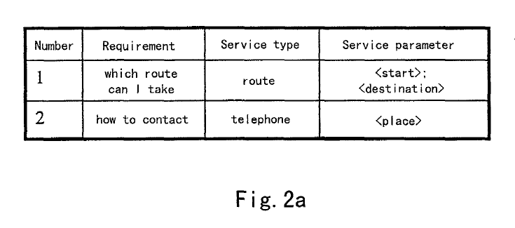

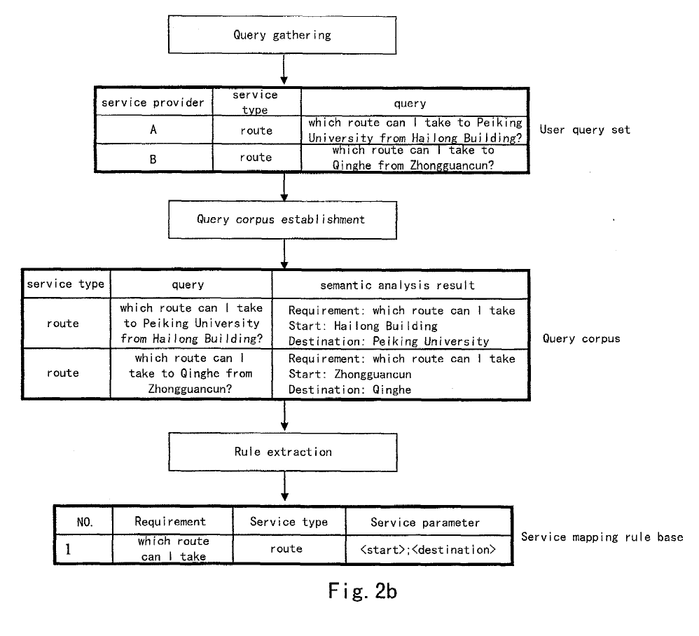

Next, the service mapping rule base 40, the service selection history base 50 and the service association database 60 will be described with reference to FIGS. 2a, 2b, 3, 4 and 5, respectively, and then the method for adaptively recommending service according to the present invention will be specifically depicted in connection with the service mapping rule base 40, the service selection history base 50 and the service association database 60.

The service mapping rule base 40 stores a plurality of set of service mapping rules. When the user query in natural language and a service mapping rule in the service mapping rule base are matched successfully, a service corresponding to the rule can be found as the service selected from all services contained in the service mapping rule base.

As shown in FIG. 2a, one piece of service mapping rule is generally composed of number, requirement, service type and service parameters. The requirement represents what is the query question from the user query, that is, the user expects to obtain which answer related to which service. The service type defines the service category to which the query question belongs. The service parameters describe service invoking interface, and the service provider can conduct retrieval based on service parameters. Each piece of rule stored in the service mapping rule base 40 represents “when a user query conforms to specified requirement, which service type the query corresponds to and what is the corresponding service parameter”. Take the first piece of mapping rule in FIG. 2a as an example, since the requirement in the user query is “which route can I take”, the query corresponds to the service type “route”, and the service parameter values are the values of service parameters (start and destination) in the query.

The service mapping rule base can be generated automatically. Referring to FIG. 2b, first, several sets of actual user queries are gathered from respective service providers. Then, a query corpus is established from the gathered user queries. Here, any semantic analyzing method in the prior art can be utilized to analyze each user query and obtain a semantic analysis result for the purpose of query corpus establishment. Lastly, the similarity between the semantic analysis results of all the queries for each service type is analyzed in the query corpus, and certain service mapping rule is extracted and written into the service mapping rule base.

For example, the above flow begins with gathering from respective route service providers various common queries, such as “which route can I take to Peiking University from Hailong Building?”, “which route can I take to Qinghe from Zhongguancun?”, etc. Then semantic analysis results are obtained through semantic analysis so as to establish a query corpus. The final step analyzes all queries for the service type “route” and extracts the common requirement “which route can I take” as well as the common parameters “start” and “destination” so as to generate a service mapping rule regarding “route”.

Although the above method generates the service mapping rule base automatically, the base can be manually generated by summarizing various service mapping rules by an operator. Alternatively, the service mapping rule base can be semi-automatically generated, that is, first generating service mapping rules automatically, and then checking them manually.

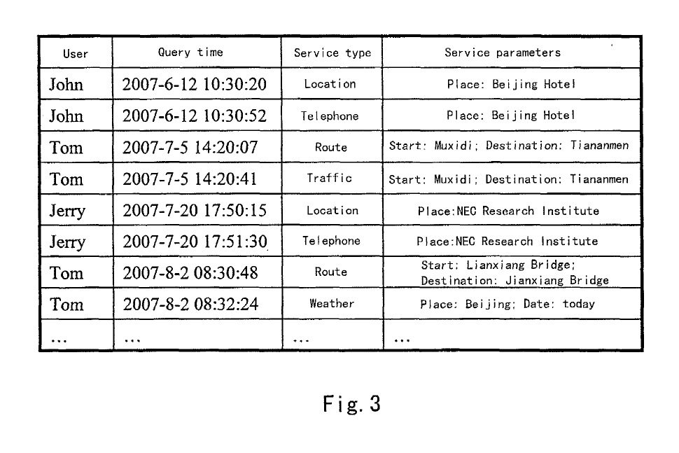

FIG. 3 shows an example of the service selection history base 50, which stores service selection records for a plurality of users. Generally, one piece of service selection record consists of user, query time, service type and service parameter, and the service parameter comprises a set of parameters each having a corresponding parameter value.

Take the first piece of user query record in FIG. 3 as an example, it represents that John made a query about location service at 10:30:20 on Jun. 12, 2007, in which the service parameter “place” has a value of “Beijing Hotel”. The service selection history base 50 can be generated automatically. In the present invention, the service selection history base 50 is modified in real time by saving the service selection result of query outputted by the service selecting unit as a piece of service selection record through the service association database updating unit 202.

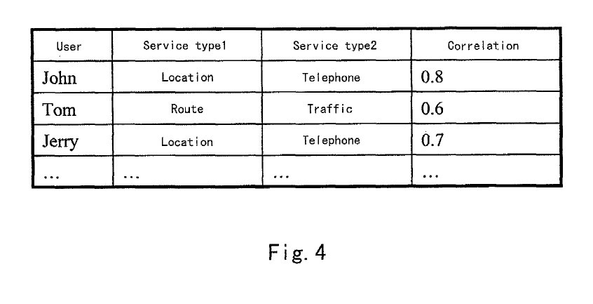

The service association database 60 stores correlation between types of different services. As shown in FIG. 4, a piece of service association record usually consists of user, service type 1, service type 2 and correlation which represents the correlative relationship between two service types for certain user. Each service association record may vary with different users since, for two service types, some users regard them as associated while others see no association between them.

For example, as shown in FIG. 4, the first record means that the correlation between location service and telephone service is 0.8 for John, while the correlation between the two services becomes 0.7 for Jerry as represented by the third record.

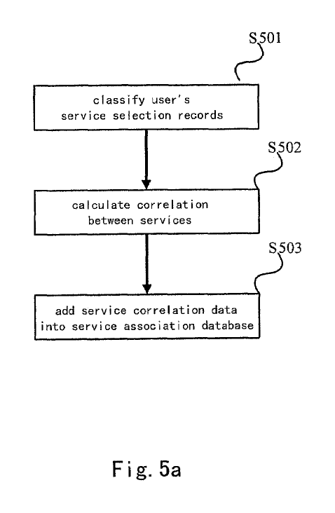

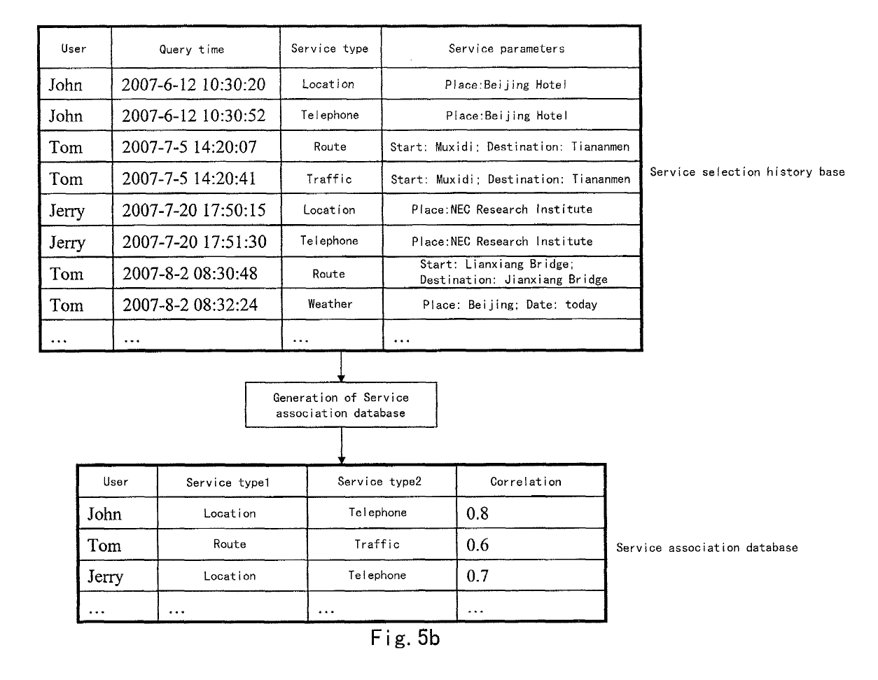

FIG. 5a shows a method of generating the service association database according to the present invention. At S501, all service selection records are first classified for different users, and those records belonging to the same user are sorted into the same category. Then, at S502, for each user, the correlation between his or her selected services is calculated. Two types of services have a higher correlation if they are queries sequentially by the user with a higher frequency. For each user, the correlation between services x and y equals to the probability that the user queries service y immediately after querying service x, and the calculation formula is:

Correlation (x,y)=P(Qₙ₊₁ has service type y|Qₙ has service type x) (1)

where the sample space is all the service selection records for the user. Finally, the service association data for each user are written in the service association database at S503. The data are particularly presented as service type 1=x, service type 2=y, correlation=Correlation (x,y).

FIG. 5b shows an example of generating the service association database. As obvious from John's service selection records, he often asks about the telephone of a place following requesting the location of the place. Therefore, the correlation between “location” and “telephone” can be calculated from the formula (I) and stored in the service association database (first piece of record).

Now, a detailed explanation will be given to the implementation of the method for adaptively recommending service in combination with the service mapping rule base, the service selection history base and the service association database.

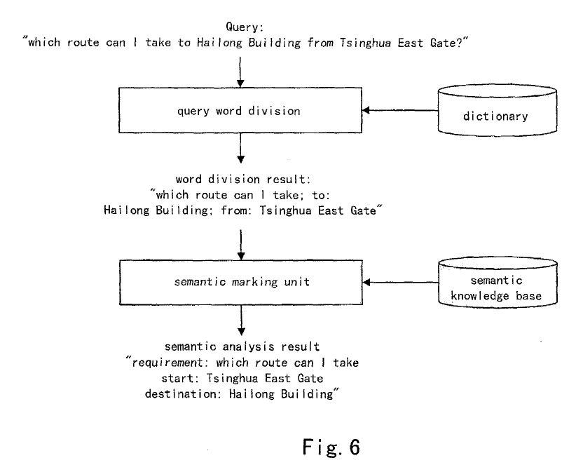

First turning to FIG. 1b, in which the input device receives a query from a user and transfers it to the semantic analyzing device 10 at S101. The semantic analyzing device 10 analyzes the received query semantically at S102. Here, any existing semantic analysis method can be employed in analyzing the received query. FIG. 6 shows a prior art semantic analysis method, which is used to understand the user's natural language query so as to obtain a structured semantic analysis result and includes a query word division step and a semantic marking step. The query word division step performs word division on the query with such resources as a dictionary, and then the semantic marking step performs semantic marking on the division result based on a semantic knowledge base so as to, generate the semantic analysis result, which is usually formed of a requirement and a query parameter. The latter may comprise a set of parameters each having a corresponding parameter value. For example, the word division result is “which route can I take; to; Hailong Building; from; Tsinghua East Gate”, according to the semantic knowledge “from <start> to <destination>”, the parameter value “Tsinghua East Gate” can be marked as the parameter type “start”, and the parameter value “Hailong Building” can be marked as the parameter type “destination”. Also, the interrogative phrase “which route can I take” can be extracted as the requirement. Then, the service selecting unit 201 selects a service at S103, to be more specific, the service selecting unit 201 searches the service mapping rule base according to the semantic analysis result of the query to find out a rule meeting the following conditions as a matched rule:
The requirement of the semantic analysis result is identical with that of the rule;
The semantic analysis result contains all the service parameters required by the rule.

After that, the service selecting unit 201 takes out the corresponding service type based on the matched rule and generates a selected service, i.e., the service selection result of query, in conjunction with the semantic analysis result, and the selected service includes its service parameter(s) and corresponding parameter value(s).

At S104, the service association database updating unit 202 adds the selected service to the service selection history base 50, and, based on the base 50, recalculates the correlation in the service association database 60 to update the database 60.

At S105, the service recommending device 30 searches the service association database 60 for service correlation data according to the selected service acquired by the service selecting unit 201, and thus determines the service associated with the selected service and recommends it to the user.

Lastly, the output device outputs the recommended service at S106.

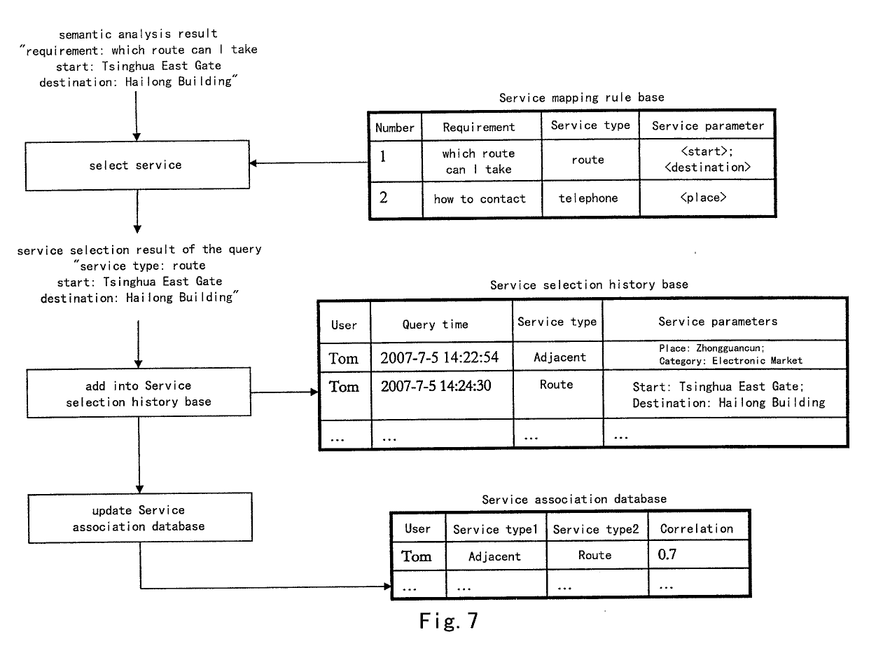

FIG. 7 shows an example in which the user query is “which route can I take to Hailong Building from Tsinghua East Gate?”, and the semantic analysis result is “requirement: which route can I take; start: Tsinghua East Gate; destination: Hailong Building”. The service selection result of this query can be obtained as “service type: route; start: Tsinghua East Gate; destination: Hailong Building”, since the above semantic analysis result has an exact matching with the service mapping rule for service type “route”, in particular, the requirements are both “which route can I take”, and the semantic analysis result contains all the parameters, i.e., “start” and “destination”, needed for the rule. Then, the service selection result of this query is added to the service selection history base, on the basis of which new service correlation data is generated as “correlation between adjacent service and route service is 0.7” by use of the method shown in FIG. 5a.

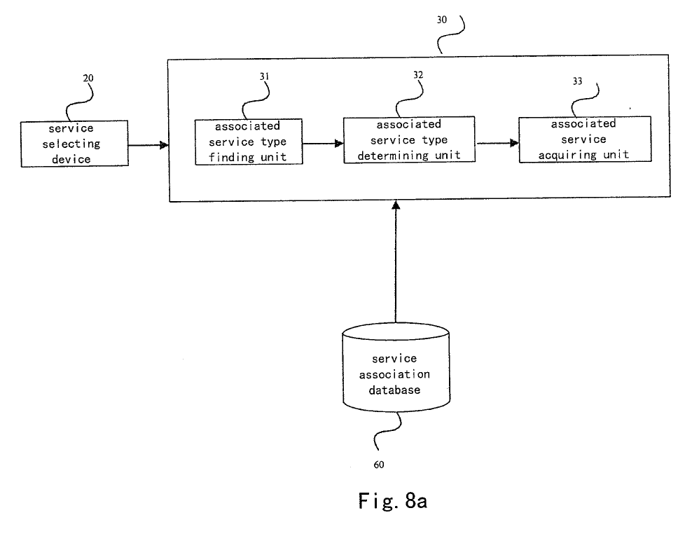

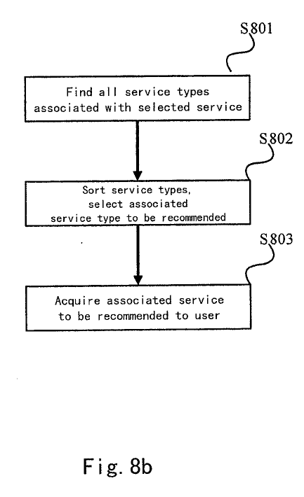

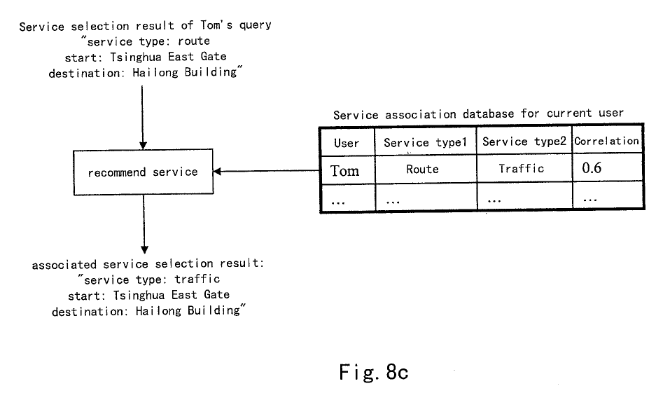

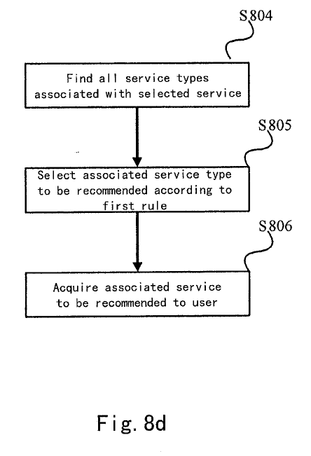

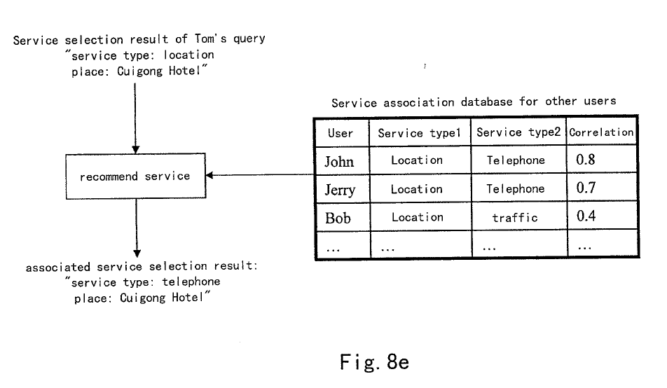

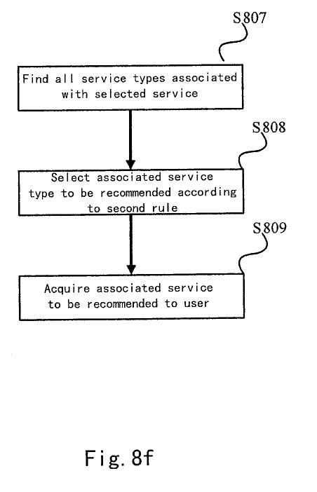

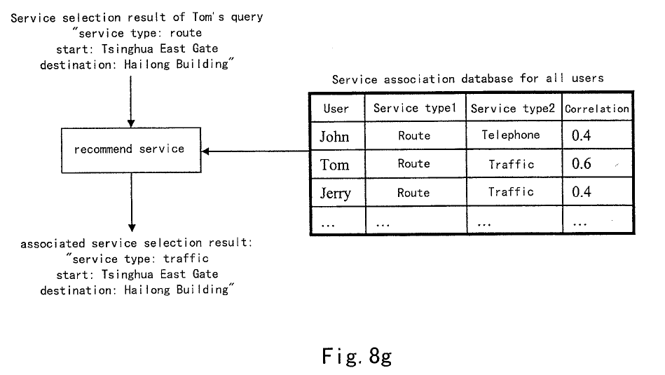

FIG. 8a shows a block diagram of the service recommending device 30 according to the present invention, which is connected to the service selecting device 20 and comprises an associated service type finding unit 31 for finding a service associated with the selected service, an associated service type determining unit 32 for determining associated service types to be selected if it is found more than one associated service types, and an associated service acquiring unit 33 for acquiring an associated service. According the present invention, the service association database 60 can be one for the current user and stores only the service correlation data for the current user who sends the query. Also, the database 60 can be one for other users and stores the service correlation data for all the users other than the current user who sends the query. Further, the database 60 can be one for all users and stores the service correlation data for the current user and other users. Naturally, the service association database 60 can also consist of two databases, one for the service correlation data of the current user, and the other for the service correlation data of all other users.

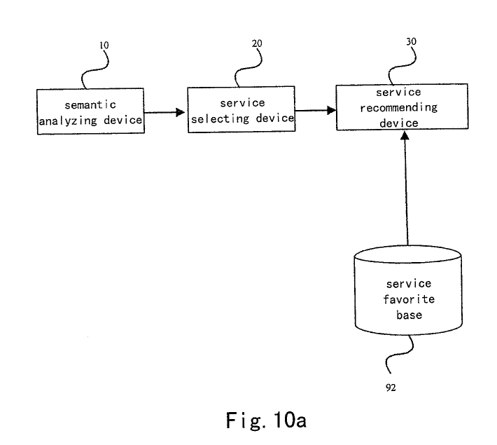

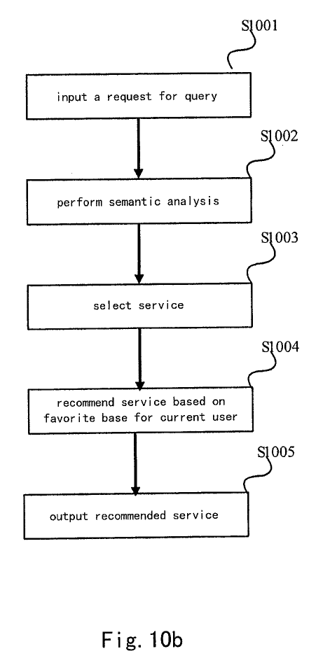

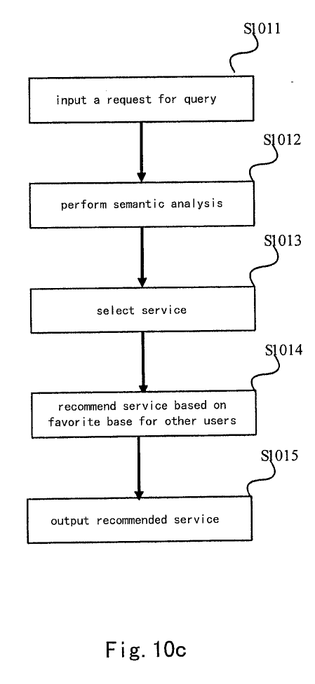

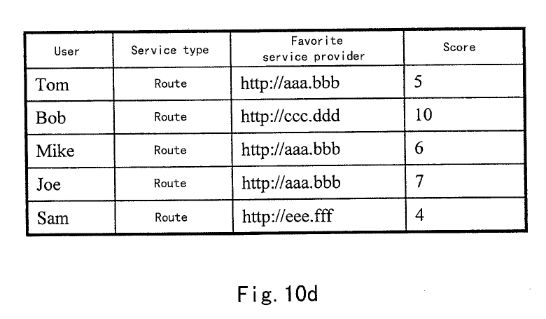

Since the service recommending device can operate on the basis of a service association database for the current user, for other user or for all users or on the basis of a service association database including a database for the current user and a database for other users, the method performed by the service recommending apparatus based on a user's favorite base will be explained with reference to FIGS. 10b and 10c, respectively.

Now, the service recommending method by the service recommending device will be described as the service association database 60 varies.

### (1) The Service Association Database 60 is the One for the Current User

FIG. 8b shows a flowchart of the service recommending method according to the first embodiment of the present invention. Referring to FIG. 8b, the associated service type finding unit 31 finds all service types associated with a selected service from the service association database for the current user at S801. Each associated service type should meet the condition that the correlation between it and the service type of the selected service is greater than a certain threshold.

At S802, the associated service type determining unit 32 sorts all the above associated service types in a descending order of correlation and accordingly selects a few service types from the top of the order as associated service types to be recommended.

At S803, the associated service acquiring unit 33 combines the associated service types with the service parameters of the service previously selected by the service selecting unit, that is, substituting the associated type for the service type in the semantic analysis result so as to obtain an associated service to be recommended to the user.

FIG. 8c shows an example, in which the user Tom makes a query of “which route can I take to Hailong Building from Tsinghua Eastern Gate?”, and the service selection result of this query is “service type: route; start: Tsinghua East Gate; destination: Hailong Building”. Based on the service correlation data for Tom, “correlation between the route and traffic is 0.6”, the system extracts the associated service type “traffic”, then combines it with the service parameters of the selection result of the query service and obtains the selection result of the associated service as “service type: traffic; start: Tsinghua East Gate; destination: Hailong Building”.

### (2) The Service Association Database 60 is the One for Other Users

FIG. 8d shows a flowchart of the service recommending method according to the second embodiment of the present invention. Referring to FIG. 8d, the associated service type finding unit 31 finds all service types associated with a selected service from the service association database for other users at S804. Each associated service type should meet the condition that the correlation between it and the service type of the selected service is greater than a certain threshold.

At S805, if more than one associated service types are obtained at the previous step, the association service type determining unit 32 selects a service type having the highest correlation from these service types as the associated service type according to a predefined first rule. Since different users may consider different correlations for the two same services, the first rule defined in the present invention is to select a service type having the highest average service correlation. The calculation of the average service correlation between service A and service B can be performed in several options:

(1) the average value of correlation between services A and B for each user;
(2) the number of users regarding that service A is associated with service B;
(3) the maximum of correlation between services A and B for each user.

At S806, the associated service acquiring unit 33 combines the associated service type and the service parameters of the service selected previously by the service selecting device, that is, replacing the service type in the semantic analysis result with the associated type, in order to obtain the associated service for recommendation to the user.

FIG. 8e shows another example, in which the user Tom queries about “where is Cuigong Hotel?”, and the service selection result of the query is “service type: location; place: Cuigong Hotel”. At first, the service types “telephone” and “traffic” in association with the service type “location” are found in the service association database for other users, and then the correlation is computed between “location” and “telephone” as well as “location” and “traffic”, respectively. The average correlation between “location” and “telephone” is 0.75 since John and Jerry regards the correlation as 0.8 and 0.7, respectively, and Bob holds that the correlation between “location” and “traffic” is 0.4. Therefore, “telephone” is selected as associated service type. After that, the associated service type is combined with the service parameters of the service selected previously to acquire an associated service “service type: telephone; place: Cuigong Hotel”.

### (3) The Service Association Database 60 is the One for all Users Including the Current User

FIG. 8f shows a flowchart of the service recommending method according to the third embodiment of the present invention. Referring to FIG. 8f, the associated service type finding unit 31 finds all service types associated with a selected service from the service association database for all users at S807. Each associated service type should meet the condition that the correlation between it and the service type of the selected service is greater than a certain threshold.

At S808, if more than one associated service types are obtained at the previous step, the association service type determining unit 32 selects a service type having the highest correlation from these service types as the associated service type according to a predefined second rule. Since different users may have taken different correlations for the same pair of two services, and the correlation held by the current user is more reliable, the second rule defined in the present invention is to select a service type having the highest weighted average service correlation, with the weight for the correlation held by the current user being the greatest and specific weights being freely set.

At S809, the associated service acquiring unit 33 combines the associated service type and the service parameters of the service selected previously by the service selecting device, that is, replacing the service type in the semantic analysis result with the associated type, in order to obtain the associated service for recommendation to the user.

FIG. 8g shows still another example, in which the user Tom makes a query of “which route can I take to Hailong Building from Tsinghua Eastern Gate?”, and the service selection result of this query is “service type: route; start: Tsinghua East Gate; destination: Hailong Building”. At first, the service types “telephone” and “traffic” in association with the service type “location” are found in the service association database for other users, and then the correlation is computed between “location” and “telephone” as well as “location” and “traffic”, respectively. The weighted average correlation between “location” and “traffic” is 0.54 since the current user Tom and another user Jerry regards the correlation as 0.6 and 0.4, respectively, and the weights assigned are 0.7 and 0.3. The correlation between “location” and “traffic” is greater than that between “location” and “telephone”, “traffic” is selected as associated type and then combined with the service parameters of the selection result and obtains the associated service as “service type: traffic; start: Tsinghua East Gate; destination: Hailong Building”.

### (4) The Service Association Database 60 Comprises a Database for the Current User and a Database for Other Users

The associated service type finding unit 31 carries out steps similar to that at S801, except that it first searches the service association database for the current user for the associated service type, and proceeds to S802 and S803 if the associated service type is found, otherwise proceeds to S804 to S806.

FIG. 1c is a schematic diagram showing an apparatus for adaptively recommending service according to a further embodiment of the present invention, which differs from that shown in FIG. 1a in that the apparatus in FIG. 1c further comprises a service correlation adjusting device 89 for adjusting the service correlation in the service association database on the basis of the feedback from the user with respect to the recommended service. In this way, the user can evaluate the associated service recommended by the apparatus, and then the apparatus adjusts the service correlation based on the user's evaluation. For the purpose of clarity, the description of like components is omitted here.

In addition to S101-S105 shown in FIG. 1b, the method for adaptively recommending service in FIG. 1d includes S107, at which the service correlation adjusting device 89 carries out adjustment through the following steps:

(1) Acquisition of user evaluation: receiving the evaluation from the user with respect to an associated service. Here, the user's evaluation can be classified in terms of association degree, and the criterion of classification can have several options as follows:
Boolean classification: “correlated” and “uncorrelated”, for example;
Degree classification: “extremely correlated”, “correlated” and “uncorrelated”, for example;
Score classification: the total score is 10, for example, and each score is given by the user.
   (2) Acquisition of correlation: acquiring the correlation corresponding to the user's evaluation. For example, the correlation corresponding to “correlated” in Boolean classification is 1, and that to “uncorrelated” is 0.
   (3) Adjustment of correlation: adjusting the corresponding value of correlation in the service association database according to the correlation from the user's evaluation. If some correlation has been assigned a value in the service association database, its value can be changed to the average value of the existing value and the correlation from the user's evaluation. If there is no value for some correlation, the correlation from the user's evaluation will be added into the service association database.

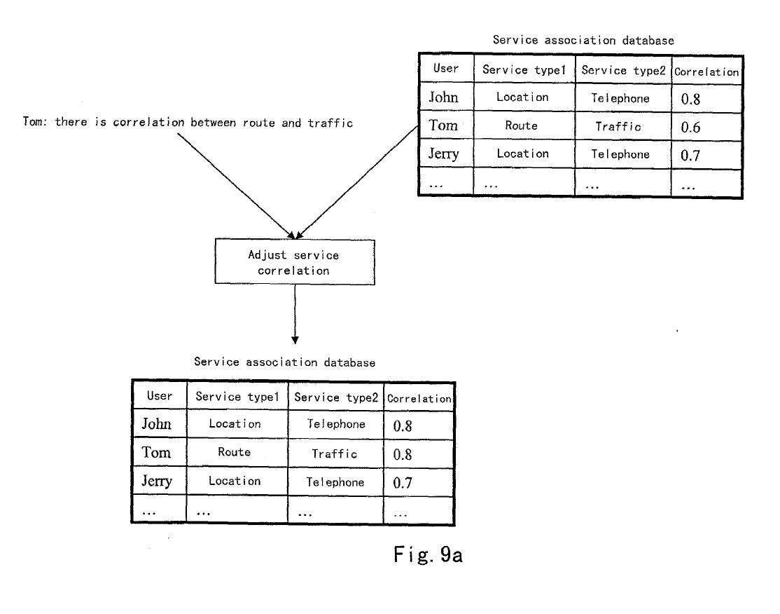

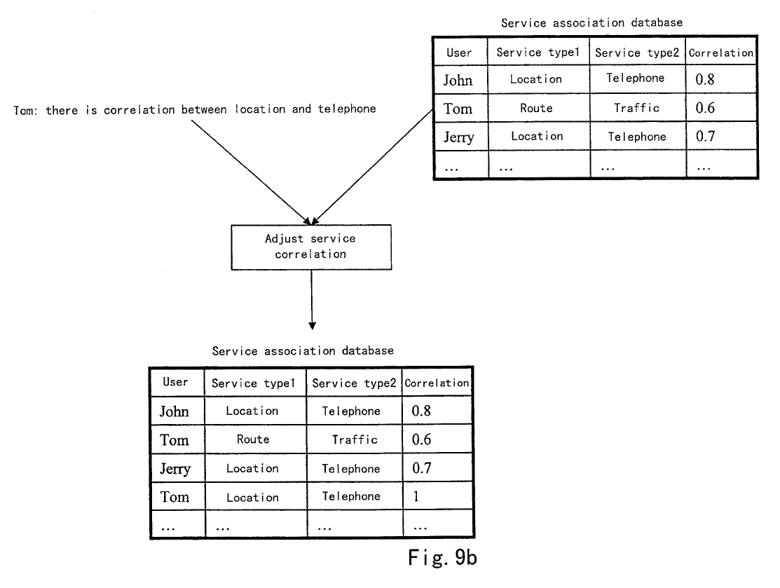

FIGS. 9a and 9b shows two example of service correlation adjustment, which receive the output results from FIGS. 8c and 8e, respectively.

As shown in FIG. 9a, after Tom has made a query of “which route can I take to Hailong Building from Tsinghua Eastern Gate?”, and the system has fed back an associated service “traffic”, Tom considers it is correlated, and the system obtains the correlation “1” from the user evaluation and then adjusts the correlation between “route” and “traffic” for Tom in the service association database from the original 0.6 to (1+0.6)/2=0.8.

As shown in FIG. 9b, after Tom has made a query of “where is Cuigong Hotel?”, and the system has fed back an associated service “telephone”, Tom considers it is correlated, and the system obtains the correlation “1” from the user evaluation and then adds a new record since there is no correlation between “location” and “telephone” for Tom.

FIG. 1e is a schematic diagram showing a system for adaptively recommending service according to the present invention, which comprises: a query receiver 202 for receiving a query from a user; a semantic analyzing device 10 for analyzing the received user query, such as a natural language query, to obtain a structured semantic analysis result; a storage device 12 comprising a service mapping rule base 40, a service selection history base 50 and a service association database 60; a service selecting device 20 for selecting a service based on the service mapping rule base 40 and adding the selected service into the service selection history base 50; a service recommending device 30 for finding a service associated with the selected service by use of the service association database 60 for recommendation to the user; a first answer generator 70 connected to the service selecting device 20 and for generating a first answer based on the selected service; a second answer generator 80 connected to the service recommending device 30 and for generating a second answer based on the recommended service; and an answer sender 90 for sending the generated answer. While two answer generators are shown in FIG. 1e, it is apparent for those skilled in the art that the system for adaptively recommending service can comprises only one of the two answer generators or only one answer generator. Further, the system may not have the storage device 12 and access a storage device external to the system itself.

FIG. 1f is a flowchart showing a method for adaptively recommending service according to the present invention. The query receiver 202 receives a query from a user at S1101. The semantic analyzing device 10 analyzes the received user query, such as a natural language query, to obtain a structured semantic analysis result at S1102. The service selecting device 20 selects a service based on the service mapping rule base 40 at S1103. The service recommending device 30 finds a service associated with the selected service by use of the service association database 60 for recommendation to the user at S1104. The first answer generator 70 generates a first answer based on the selected service at S1105. The second answer generator 80 generates a second answer based on the recommended service at S1106. At the final step of S1107, The answer sender 90 sends the generated first and second answers.

FIG. 10a is a schematic diagram showing an apparatus for recommending service based on a user's favorite base. The existing methods usually make access to predefined fixed service providers according to the service selection result. For example, given that the system predefines the service providers for “route” are A and B, it will access A and B each time a route query is processed.

On the other hand, the apparatus for recommending service based on a user's favorite base of the present invention makes access to the optimal service providers based on the user's favorite base and may prompt the user to update his or her favorite base.

Referring to FIG. 10a, the apparatus for recommending service based on a user's favorite base comprises an input device (not shown) for receiving a query from the user, a semantic analyzing device 10, a service selecting device 20 connected to the semantic analyzing device 10, a service recommending device 30 for recommending a service provider to the user based on the user's favorite base, and an output device (not shown) for outputting the recommendation result.

The user's favorite base 92 stores favorite records for all users. This system allows a user to collect his or her favorite service providers.

As shown in FIG. 10d, one piece of user's favorite record usually consists of user, service type, favorite service provider and score and the meaning of the record is, for certain service type, which service provider is the user's favorite and what is his or her evaluation on the service provider (with a total score being 10).

Take the first piece of record in FIG. 10d as an example, the service provider with URL of http://aaa.bbb is Tom's favorite, and he evaluates the service provider's performance in handling route service at a score of 5.

The user's favorite base is primarily filled in by users, and the system can also recommend service providers to the users.

The user's favorite base can stores only the records of the current user's favorite, i.e., a favorite base for the current user; it can also stores the favorite records of users other than the current user, i.e., a favorite base for other users.

Since the apparatus for recommending service based on a user's favorite base can operate based on a favorite base for the current user or a favorite base for other users, the method used with such apparatus will be explained with respect to FIGS. 10b and 10c, respectively.

FIG. 10b is a flowchart showing the method for recommending service based on a favorite base for the current user. The input device receives a query inputted by a user at S1001. The semantic analyzing device 10 analyzes the user query semantically S1002. The service selecting device 20 finds a selected service corresponding to the user query by using the semantic analysis result at S1003. The service recommending device 30 at S1004 finds from the current user's favorite base a pieces of record having the same service type as that of the service selection result, and then extracts the corresponding service provider for recommendation to the user. At the final step of S1005, The recommended service provider is outputted to the user by the output device.

FIG. 10c is a flowchart showing the method for recommending service based on a favorite base for other users. The input device receives a query inputted by a user at S1011. The semantic analyzing device 10 analyzes the user query semantically S1012. The service selecting device 20 finds a selected service corresponding to the user query by using the semantic analysis result at S1013. The service recommending device 30 at S1014 finds first from other users' favorite base a pieces of record having the same service type as that of the service selection result, and then selects a service provider for recommendation to the user. Here, the selection can be implemented in the following three manners:

a) selecting a service provider having the highest score given by users
b) selecting a service provider that is the most favorite of users, and
c) selecting all service providers, and then determining the optimum service provider by the user.

At the final step of S1015, The recommended service provider is outputted to the user by the output device.

In addition, the above method for recommending service based on a user's favorite base can prompt the user to add the service provider recommended by the system into his or her favorite base.

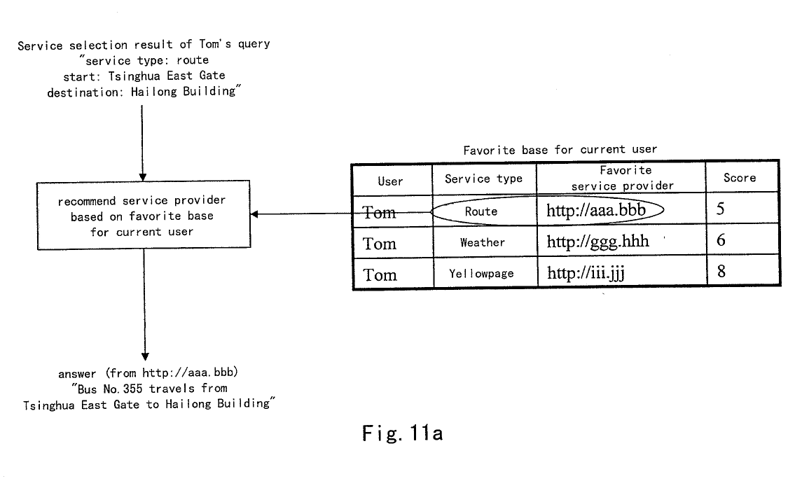

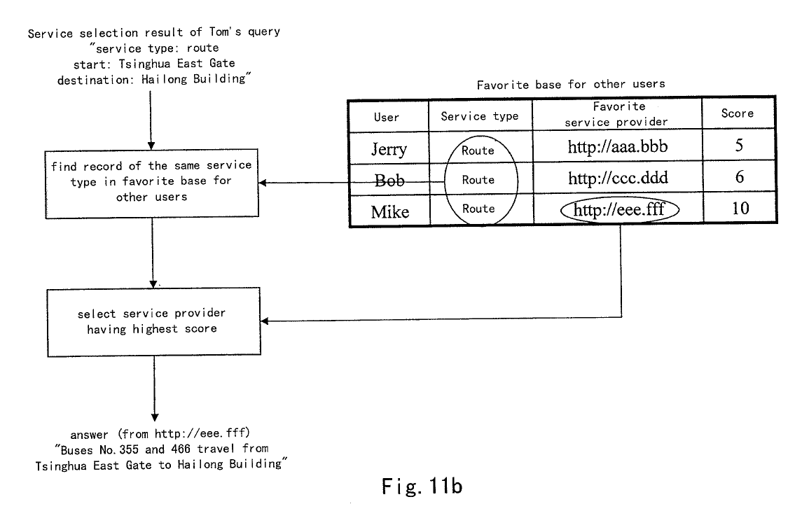

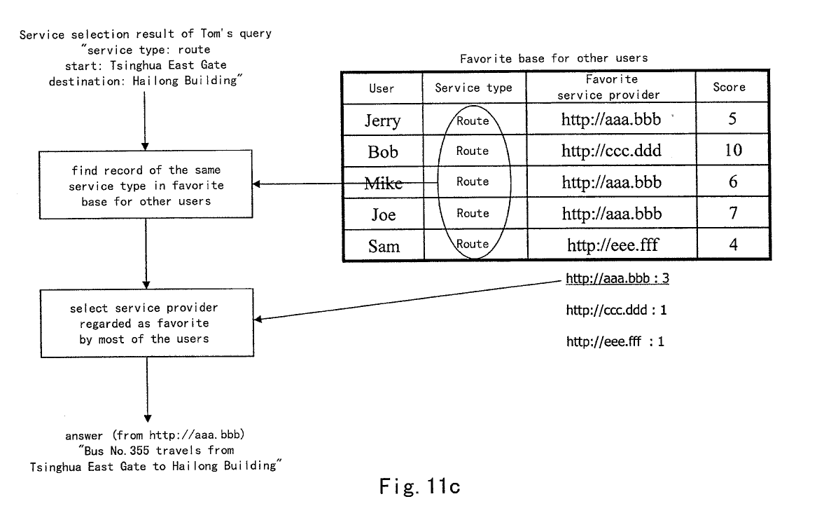

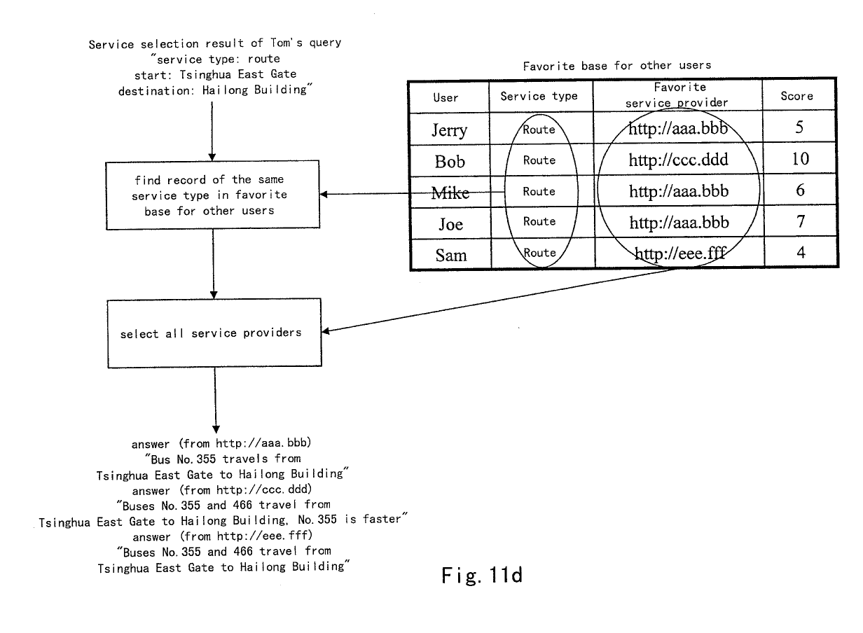

FIGS. 11a-11d show four examples of recommending method based on a user's favorite base, each of the examples returns an answer corresponding to Tom's query of “which route can I take to Hailong Building from Tsinghua Eastern Gate?”, and the service selection result of the query is “service type: route; start: Tsinghua Eastern Gate; destination: Hailong Building”.

FIG. 11a shows an example of recommending a service provider based on a favorite base for the current user. Here, the service provider http://aaa.bbb will be accessed since it is Tom's favorite.

FIG. 11b shows an example of recommending a service provider based on a favorite base for other users, with the recommendation criterion being the highest score from users. Among the three route service providers as the favorite of other users, http://eee.fff will be accessed other than http://aaa.bbb and http://ccc.ddd because http://eee.fff has the highest score (10).

FIG. 11c shows an example of recommending a service provider based on a favorite base for other users, with the recommendation criterion being a service provider regarded as favorite by most of the users. Among the three route service providers as the favorite of other users, http://aaa.bbb, http://ccc.ddd and http://eee.fff, the first one is regarded as favorite by up to three users and thus accessed.

FIG. 11d shows an example of recommending a service provider based on a favorite base for other users, with the recommendation criterion being all service providers. Three route service providers are taken as the favorite of other users, http://aaa.bbb, http://ccc.ddd and http://eee.fff, and will be accessed.

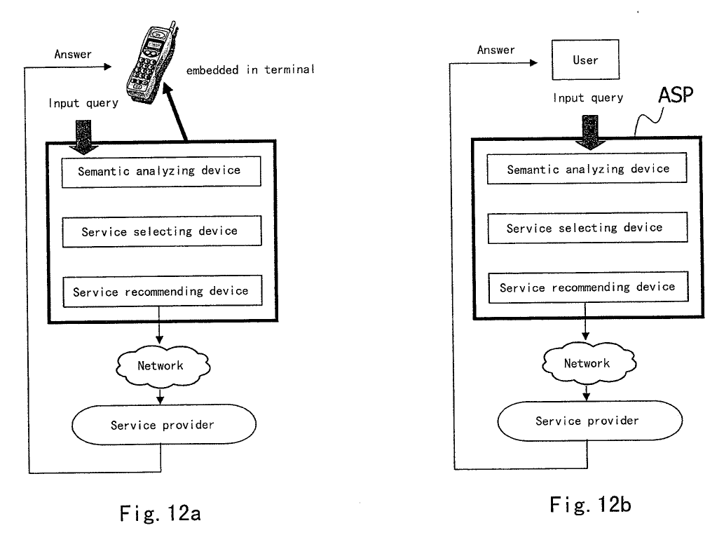

FIGS. 12a and 12b show a schematic diagram for applying the apparatus for adaptively recommending service according to the present invention to a mobile terminal and an ASP (Active Server Page), respectively. As shown in FIG. 12a, the semantic analyzing device, the service selecting portion and the service recommending device can be embedded together into the mobile terminal. Now turning to FIG. 12b, the semantic analyzing device, the service selecting portion and the service recommending device can also be embedded into the ASP so as to recommend associated services to the user in an easier and quicker way.

While the present invention has been described with reference to the above particular embodiments, the present invention should be defined by the appended claims other than these specific embodiments. It is obvious to those ordinarily skilled in the art that any change or modification can be made without departing from the scope and spirit of the present invention.

What is claimed is:

1. An apparatus for adaptively recommending service, comprising:
a semantic analyzing device which analyzes the query from a user semantically;
a service selecting device which selects a service which corresponds to the semantically-analyzed query, and updates a service association database according to the selected service; and
a service recommending device which searches the service association database according to the selected service to recommend a related service to the user.

2. The apparatus according to claim 1, wherein the service selecting device comprises:
a service selecting unit which searches a rule matched with the semantically-analyzed query from a service mapping rule base, and acquires the selected service based on the matched rule; and
a service association database updating unit which adds the selected service into a service selection history base, and recalculates a service correlation to update the service association database.

3. The apparatus according to claim 2, wherein the service selecting unit finds the service mapping rule which meets the following conditions from the service mapping rule base as a matched rule:
the requirement in the service mapping rule is identical to the requirement in the semantically-analyzed query; and
the service parameter in the service mapping rule is contained in the service parameter in the semantically-analyzed query.

4. The apparatus according to claim 2, wherein the service association database updating unit adds the selected service into a service selection record that belongs to the same user as that of the query in the service selection history base, and recalculates the service correlation with respect to the user so as to update the service association database.

5. The apparatus according to claim 1, wherein the service recommending device comprises a current user based service recommending device which recommends a related service to the user by using the service association database of the current user.

6. The apparatus according to claim 5, wherein the current user based service recommending device comprises:
a related service type finding unit which finds a service type that is related to the selected service from the service association database of the current user; and
a related service acquiring unit which replaces the service type in the semantically-analyzed query with the related service type so as to acquire the related service recommended to the user.

7. The apparatus according to claim 6, wherein the related service type finding unit finds the service type whose correlation with the service type of the selected service is greater than a predetermined threshold, as a related service type.

8. The apparatus according to claim 6, wherein the current user based service recommending device further comprises:
a related service type determining unit which sorts the correlation s of all related service types in a descending order when at least two related service types are found, selects the related service type with high correlation according to the sorting result, and provides to the related service acquiring unit.

9. The apparatus according to claim 1, wherein the service recommending device comprises an other user based service recommending device which recommends a related service to the current user by using the service association database of other users.

10. The apparatus according to claim 9, wherein the other user based service recommending device comprises:
a related service type finding unit which finds a service type that is related to the selected service from the service association database of other users; and
a related service acquiring unit which replaces the service type in the semantically-analyzed query with the related service type so as to acquire the related service recommended to the user.

11. The apparatus according to claim 10, wherein the related service type finding unit finds the service type whose correlation with the service type of the selected service is greater than a predetermined threshold, as a related service type.

12. The apparatus according to claim 10, wherein the other user based service recommending device further comprises:
a related service type determining unit which selects the related service type according to a first predetermined rule when at least two related service types are found, and provides to the related service acquiring unit.

13. The apparatus according to claim 1, wherein the service recommending device comprises:
a current user based service recommending device which recommends a first related service to the user by using the service association database of the current user; and
an other user based service recommending device which recommends a second related service to the user by using the service association database of other users when the first related service is not recommended.

14. The apparatus according to claim 1, wherein the service recommending device comprises an all user based service recommending device which recommends a related service to the user by using the service association database of the all user.

15. The apparatus according to claim 14, wherein the all user based service recommending device comprises:
a related service type finding unit which finds a service type that is related to the selected service from the service association database of the all user; and
a related service acquiring unit which replaces the service type in the semantically-analyzed query with the related service type so as to acquire the related service recommended to the user.

16. The apparatus according to claim 15, wherein the related service type finding unit finds the service type whose correlation with the service type of the selected service is greater than a predetermined threshold, as a related service type.

17. The apparatus according to claim 15, wherein the all user based service recommending device further comprises:
a related service type determining unit which selects the related service type according to a second predetermined rule when at least two related service types are found, and provides to the related service acquiring unit.

18. The apparatus according to claim 1, wherein the apparatus further comprises:
a service correlation adjusting device which dynamically adjusts the service correlation in the service association database according to the feedback from the user evaluating the related service recommended by the service recommending device.

19. A method of adaptively recommending service, comprising:
a semantic analyzing step of analyzing the query from a user semantically;
a service selecting step of selecting a service which corresponds to the semantically-analyzed query, and updating a service association database according to the selected service; and
a service recommending step of searching the service association database according to the selected service to recommend a related service to the user.

20. The method according to claim 19, wherein the service selecting step comprises:
a service selecting step of searching a rule matched with the semantically-analyzed query from a service mapping rule base, and acquiring the selected service based on the matched rule; and
a service association database updating step of adding the selected service into a service selection history base, and recalculating a service correlation to update the service association database.

21. The method according to claim 20, wherein the service selecting step comprising a step of finding the service mapping rule which meets the following conditions from the service mapping rule base as a matched rule:
the requirement in the service mapping rule is identical to the requirement in the semantically-analyzed query; and
the service parameter in the service mapping rule is contained in the service parameter in the semantically-analyzed query.

22. The method according to claim 20, wherein the service association database updating step comprises a step of adding the selected service into a service selection record that belongs to the same user as that of the query in the service selection history base, and recalculating the service correlation with respect to the user so as to update the service association database.

23. The method according to claim 19, wherein the service recommending step comprises a current user based service recommending step of recommending a related service to the user by using the service association database of the current user.

24. The method according to claim 23, wherein the current user based service recommending step comprises:
a related service type finding step of finding a service type that is related to the selected service from the service association database of the current user; and
a related service acquiring step of replacing the service type in the semantically-analyzed query with the related service type so as to acquire the related service recommended to the user.

25. The method according to claim 24, wherein the related service type finding step comprises a step of finding the service type whose correlation with the service type of the selected service is greater than a predetermined threshold, as a related service type.

26. The method according to claim 24, wherein the current user based service recommending step further comprises:
a related service type determining step of selecting the related service type according to a first predetermined rule when at least two related service types are found, and providing to the related service acquiring step.

27. The method according to claim 19, wherein the service recommending step comprises an other user based service recommending step of recommending a related service to the current user by using the service association database of other users.

28. The method according to claim 27, wherein an other user based service recommending step comprises:
a related service type finding step of finding a service type that is related to the selected service from the service association database of other users; and
a related service acquiring step of replacing the service type in the semantically-analyzed query with the related service type so as to acquire the related service recommended to the user.

29. The method according to claim 28, wherein the related service type finding step comprises a step of finding the service type whose correlation with the service type of the selected service is greater than a predetermined threshold, as a related service type.

30. The method according to claim 28, wherein the other user based service recommending step further comprises:
a related service type determining step of sorting the correlations of all related service types in a descending order when at least two related service types are found, selecting the related service type with high correlation according to the sorting result, and providing to the related service acquiring step.

31. The method according to claim 19, wherein the service recommending step comprises:
a current user based service recommending step of recommending a first related service to the user by using the service association database of the current user; and
an other user based service recommending step of recommending to the user a second related service by using the service association database of other users when the first related service is not recommended.

32. The method according to claim 19, wherein the service recommending step comprises an all user based service recommending step of recommending a related service to the user by using the service association database of the all user.

33. The method according to claim 32, wherein the all user based service recommending step comprises:
a related service type finding step of finding a service type that is related to the selected service from the service association database of the all user; and
a related service acquiring step of replacing the service type in the semantically-analyzed query with the related service type so as to acquire the related service recommended to the user.

34. The method according to claim 33, wherein the related service type finding step comprises a step of finding the service type whose correlation with the service type of the selected service is greater than a predetermined threshold, as a related service type.

35. The method according to claim 33, wherein the all user based service recommending step further comprises:
a related service type determining step of selecting the related service type according to a second predetermined rule when at least two related service types are found, and providing to the related service acquiring step.

36. The method according to claim 19, wherein the method further comprises:
a service correlation adjusting step of dynamically adjusting the service correlation in the service association database according to the feedback from the user evaluating the related service recommended by the service recommending step.

37. A system for adaptively recommending service, comprising:
a query receiver which receives a user query;
a semantic analyzing device which analyzes the query semantically;
a service selecting device which selects a service which corresponds to the semantically-analyzed query, and updates a service association database according to the selected service; and
a service recommending device which searches the service association database according to the selected service to recommend related service to the user;
a first answer generator which generates an answer corresponding to the related service;
an answer sender which sends the answer to the user.

38. A system according to claim 37, wherein the system further comprises a second answer generator which generates an answer corresponding to the selected service.

39. A method of adaptively recommending service, comprising:
a query receiving step of receiving a user query;
a semantic analyzing step of analyzing the query semantically;
a service selecting step of selecting a service which corresponds to the semantically-analyzed query, and updating a service association database according to the selected service; and
a service recommending step of searching the service association database according to the selected service to recommend related service to the user;
a first answer generating step of generating an answer corresponding to the related service;
an answer sending step of sending the answer to the user.

40. A method according to claim 39, wherein the method further comprises a second answer generating step of generating an answer corresponding to the selected service.

41. An apparatus for recommending service based on user's favorite base, comprising:
a semantic analyzing device which analyzes the query from a user semantically;
a service selecting device which selects a service which corresponds to the semantically-analyzed query; and
a service recommending device which searches the user's favorite base according to the selected service to recommend a service provider to the user.

42. The apparatus according to claim 41, wherein the service recommending device searches the record whose service type is the same as that of the selected service from the current user's favorite base, and extracts the corresponding service provider.

43. The apparatus according to claim 41, wherein the service recommending device searches the record whose service type is the same as that of the selected service from other users' favorite base according to a predetermined rule, and extracts the corresponding service provider.

44. The apparatus according to claim 43, wherein the predetermined rule comprises one of the followings: selecting the service provider having the highest scores from users, selecting the service provider that is the most favorite for users, and selecting the optimum service provider by the user.

45. A method of recommending service based on user's favorite base, comprising:
a semantic analyzing step of analyzing the query from a user semantically;
a service selecting step of selecting a service which corresponds to the semantically-analyzed query; and
a service recommending step of searching the user's favorite base according to the selected service to recommend a service provider to the user.

46. The method according to claim 45, wherein the service recommending step comprises a step of searching the record whose service type is the same as that of the selected service from the current user's favorite base, and extracting the corresponding service provider information.

47. The method according to claim 45, wherein the service recommending step comprises a step of searching the record whose service type is the same as that of the selected service from other users' favorite base according to a predetermined rule, and extracting the corresponding service provider.

48. The method according to claim 47, wherein the predetermined rule comprises one of the followings: selecting the service provider having the highest scores from users, selecting the service provider that is the most favorite for users, and selecting the optimum service provider by the user.
